(19) United States
(12) Patent Application Publication
(10) Pub. No.: US 2014/0332094 A1
(43) Pub. Date: Nov. 13, 2014

(54) PARTS WASHER ASSEMBLY WITH EXTERNALLY MOUNTED PUMP MOTOR

(71) Applicant: Rudy Publ, Glendale Heights, IL (US)

(72) Inventor: Rudy Publ, Glendale Heights, IL (US)

(73) Assignee: SAFETY-KLEEN SYSTEMS, INC., Norwell, MA (US)

(21) Appl. No.: 13/892,036

(22) Filed: May 10, 2013

(51) Int. Cl. B08B 3/00; F16B 5/00; B08B 3/10

(52) U.S. Cl. CPC B08B 3/006; B08B 3/106; B08B 3/102; F16B 5/00
USPC 137/334; 137/565.01; 29/402.01; 417/410.1; 417/423.14; 403/335

(57) ABSTRACT

A parts washer assembly containing a volume of cleaning solution and a receptacle disposed on top of a tank holding the cleaning solution may comprise a control unit disposed on top of the tank and covering a portion of an opening of the tank and a pump assembly including a motor and extension wherein the motor is located above the control unit and the extension extends into the tank of cleaning solution.

### BACKGROUND

In numerous industries, such as, for example only, in performing mechanical or repair services and operations in automobile service centers, manufacturing facilities, machine shops, garages and the like, there exists a need to clean component mechanical parts prior to repair, inspection, or replacement. Generally, such parts have been exposed to various contaminants such as dirt, oil, grease and the like, which must be removed for effective repair or service. In the prior art, a variety of washing devices and techniques have been used to provide the requisite cleaning of the components as needed. One such technique includes the use of a parts washer assembly in which cleaning solution is dispensed and used to wash contaminated parts.

Typical parts washers with which the subject matter of the present invention is useful are parts washers of the type described in U.S. Pat. Nos. 3,522,814, 4,049,551, 4,261,378, 5,598,861, 5,720,308, 6,874,512, 7040,161, 7,740,711, 7,875,127, and 8,016,946, each of which is incorporated by reference in its entirety herein. These patents generally describe parts washers wherein a sink is positioned atop a barrel-type reservoir and in which a submersible pump in the reservoir circulates cleaning liquid from the reservoir to the interior of a sink in which parts are disposed for washing. While the washing is being carried out, cleaning liquid continually drains from an opening in the bottom of the sink back into the reservoir.

Over the years, the most successful parts washers have been those that can be readily and economically serviced. Servicing has consisted of changing the cleaning liquid, the filter, if any, and a general machine clean-up. In use, cleaning liquid used in a parts washer becomes increasingly dirty until its ability to clean is compromised by the presence of dispersed contaminants and/or soluble oils and greases. Service may also include replacing the entire heater and/or pump module and any control mechanisms connected thereto as a result of operational failure.

The present invention involves the discovery that earlier parts washers, however successful, have several disadvantages. First, the parts washers are not easily field serviceable. If one component of the control and/or pump assembly fails, the entire unit must be replaced. For example, the pump is the source of a majority of problems related to operability. Many pump failures are the result of a failure in the electrical motor such as a short circuit. The pump and/or motor housings are usually plastic and commonly attached to a distal end of a conduit used to route power control wires for the pump motor. A metallic fitting interfaces the conduit to the pump and/or motor housing. Cracks develop in the housing at the interface as a result of pump vibrations and the surrounding environment. As a result of this disadvantage, the pump and/or motor often fails and the entire unit must be replaced. Consequently, costs to the vendor and ultimately the customer are constantly increased.

In addition, the pump assembly in earlier parts washers were housed in the tank of cleaning solution either submerged or sometimes floating in the solution. The moisture and vapors of the cleaning solution presents an environment that can accelerate the degradation of the materials of the different components and can lead to increased frequency of operational failure.

Another disadvantage of many earlier parts washers is that there is often no protection against current leakage. This disadvantage is especially true with respect to parts washers that use aqueous cleaning solutions that can conduct electricity. This situation results in an increased likelihood of injury should an operator come into contact with an energized component.

Therefore, there is a need for an improved parts washer assembly having a configuration that allows for improved serviceability that may include increased modularity. A need also exists for a parts washer assembly with a configuration that increases the operational life of the multiple elements of the parts washer assembly. A further need exists for a parts washer assembly that provides additional safety to the users thereof.

### SUMMARY

In one embodiment, a parts washer assembly containing a volume of cleaning solution and a receptacle disposed on top of a tank holding the cleaning solution may comprise a control unit disposed on top of the tank and covering a portion of an opening of the tank and a pump assembly including a motor and extension wherein the motor is located above the control unit and the extension extends into the tank of cleaning solution.

In another embodiment, the control unit of the parts washer assembly may further include at least one connection point located outside of the tank.

In another embodiment, the control unit of the parts washer assembly may also include at least one connection point located outside of the tank and a motor that is connected to the connection point.

In another embodiment, the parts washer assembly as described above also includes a ground fault interrupter (GFI) or ground fault circuit interrupter (GFCI) unit. In this embodiment the GFCI unit includes a unique electrical connector configuration complimentary to a power cord of the parts washer assembly.

In still another embodiment, the parts washer assembly described above further includes a heating assembly connected to the pump assembly.

In yet another embodiment, the control unit of the parts washer assembly further comprises a shell including a connection surface, a flange extending downward from the shell, and at least one connection point located on the connection surface. In this embodiment, the connection point is located outside the tank and the flange of the control unit extends downward into the tank.

### DESCRIPTION OF THE DRAWINGS

The following disclosure as a whole may be best understood by reference to the provided detailed description when read in conjunction with the accompanying drawings, drawing description, abstract, summary, detailed description, background, and other headings, where included. Identical reference numerals when found on different figures identify the same elements of a functionally equivalent element. The elements listed in the abstract are not referenced but nevertheless refer by association to the elements of the detailed description and associated disclosure.

FIG. 1 is a cut-away view of a parts washer assembly in accordance with one embodiment of the present disclosure.

FIG. 2 is an illustration of a parts washer module in accordance with one embodiment of the present disclosure.

FIG. 3 is an illustration of a control unit in accordance with one embodiment of the present disclosure.

FIG. 4 is an illustration of an exploded view of a GFCI unit in accordance with one embodiment of the present disclosure.

FIG. 5 is a rear cut-away of a parts washer assembly in accordance with one embodiment of the present disclosure.

FIG. 6 is an illustration of a parts washer assembly in accordance with one embodiment of the present disclosure.

FIG. 7 is an illustration of a control unit in accordance with one embodiment of the present disclosure.

FIG. 8 is an illustration of an embodiment of a cover plate according to one embodiment of the present disclosure.

FIG. 9. is an illustration of a parts washer assembly in accordance with another embodiment of the present disclosure.

FIG. 10 is an illustration of a parts washer assembly in accordance with another embodiment of the present disclosure.

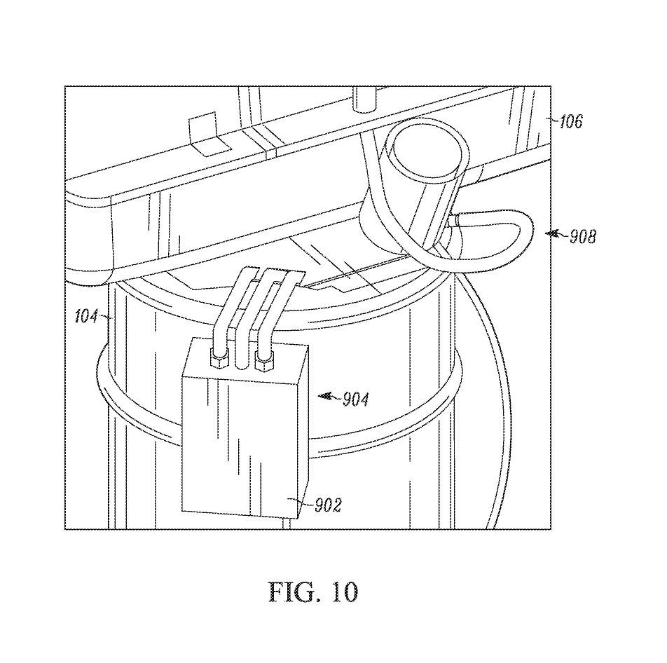

FIG. 11 is an illustration of a heating assembly in accordance with another embodiment of the present disclosure.

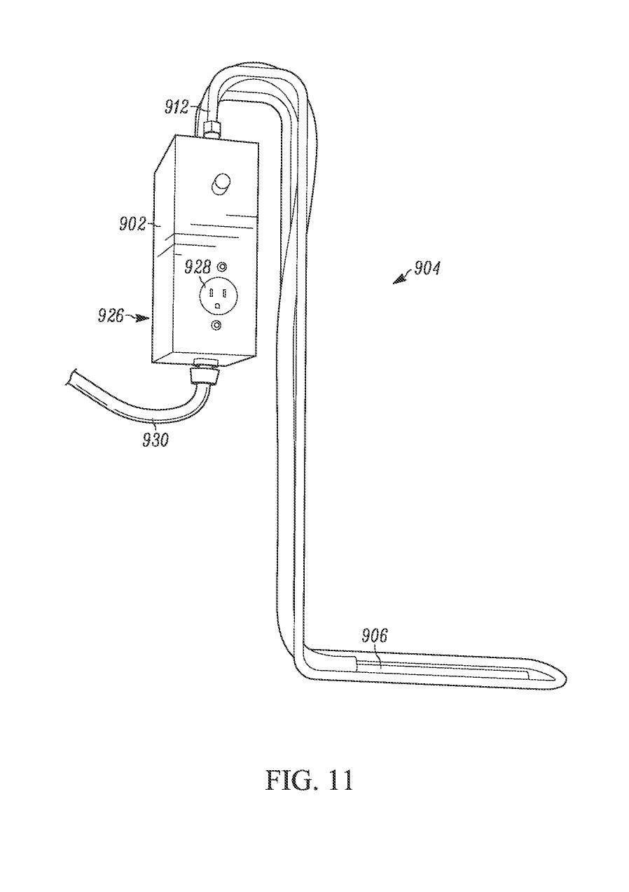

FIG. 12 is an illustration of a pump assembly in accordance with another embodiment of the present disclosure.

### DETAILED DESCRIPTION

The present invention is not limited to the particular details of the assemblies depicted, and other modifications and applications may be contemplated. Further changes may be made in the assemblies without departing from the true spirit of the scope of the disclosure herein involved. It is intended, therefore, that the subject matter in this disclosure should be interpreted as illustrative, not in a limiting sense.

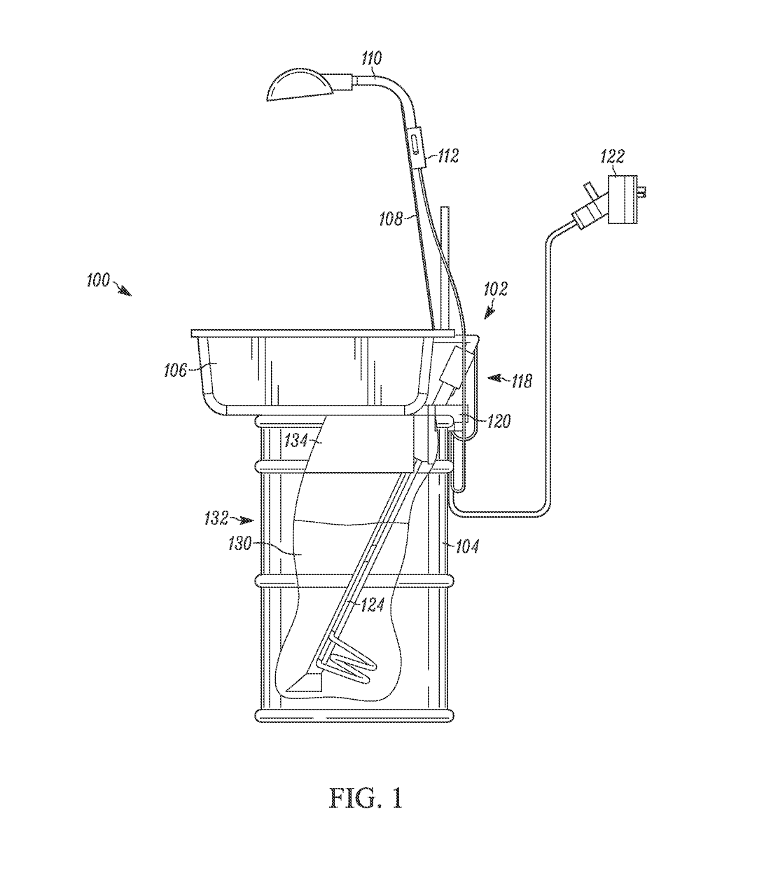

One embodiment of the present disclosure is illustrated in FIG. 1. The parts washer assembly 100, in this embodiment, may include tank 104, receptacle 106, lid 108, lamp 110, ground fault circuit interrupter (GFCI) unit 122, and parts washer module 102. Parts washer assembly 100 may optionally include all the aforementioned components or a subset of these components as well.

In the embodiment shown in FIG. 1, tank 104 is a cylindrical steel drum with a capacity of 16 or 30 gallons. Other sizes, capacities, and configurations of tank 104 may also be used as known to those of ordinary skill in the art. For example, a rectangular or oval-shaped tank can also be used so long as the volume is capable of holding a desired quantity of cleaning solution 130.

In this embodiment, parts washer assembly 100 additionally includes receptacle 106. Receptacle 106, in one example, is a steel sink. Receptacle 106 includes upward facing walls and a bottom such that a parts cleaning chamber is defined for the placement of parts that can be cleaned within parts washer assembly 100. Receptacle 106 may also include a downward extending collar 134 that extends below the bottom of receptacle 106 and interfaces with tank 104 such that receptacle 106 is retained in position relative to tank 104. As can be appreciated by one of ordinary skill in the art, receptacle 106 may additionally include lid 108, drain and dispenser assembly. In this example, lid 108 may be connected to the upward facing walls of receptacle 106 with hinges such that lid 108 can be raised and lowered during periods of use and non-use. Drain can be used to return cleaning solution to tank 104 that is used during the cleaning of parts with cleaning solution that is dispensed from dispenser assembly.

Further mounted to lid 108, in this example, is lamp 110 and lamp control 112. Lamp 110 may be any suitable light known to one of ordinary skill in the art. In one example a conventional, incandescent light bulb with a steel housing and goose-neck arm is used but other light sources and lamp configurations may also be used. Lamp control 112 includes lamp switch 114 that can be used to activate lamp 110 and may also be connected to control unit 300 for further functionality as will be explained later.

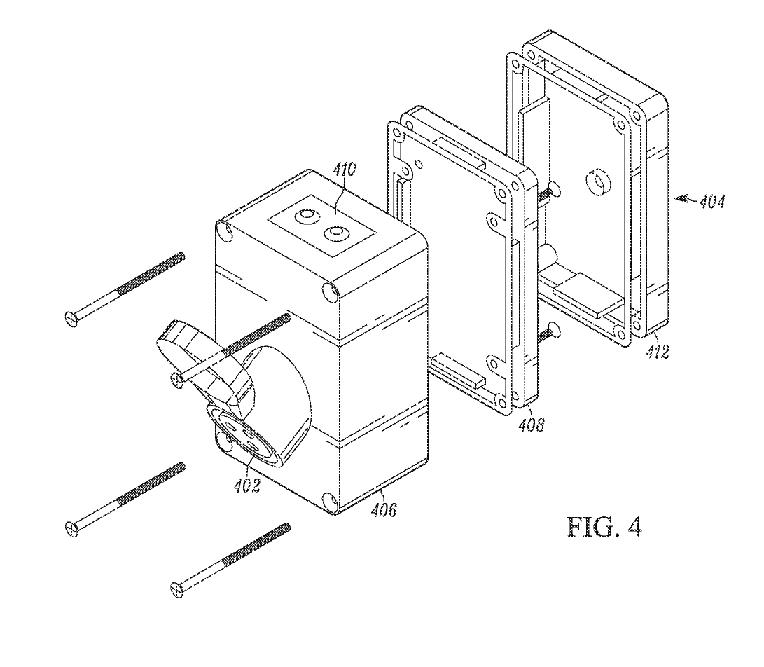

As shown in FIG. 1 and shown in further detail in FIG. 4, parts washer assembly 100 may include ground fault circuit interrupter (GFCI) unit 122. GFCI unit 122 provides disconnection of electric current in the event that a current leakage is detected. In this manner, GFCI unit 122 disconnects electric current from parts washer assembly 100 in the event that current is leaking, such as through an operator of the parts washer assembly, to provide additional safety.

GFCI unit 122, in one embodiment shown in exploded view in FIG. 4, includes power output 402, power input 404, housing 406, back plate 408, rear cover 412, and reset mechanism 410. Power output 402 is the element of GFCI unit 122 in which power is transferred from a power source, through the GFCI circuitry and to parts washer assembly 100. In one example, power output 402 is a female 3-prong grounded electrical outlet. Other configurations can also be used, however, such as other complimentary male to female plug connections. In another example, power output 402 may be in the form of a female receptacle but the plug is configured such that a conventional 3-prong or 2-prong male plug cannot be inserted into power output 402. In this embodiment a unique configuration of electrical attachment exists on power output 402. One example of a unique configuration would be the embodiment shown in FIG. 4, however other configurations known to one of ordinary skill in the art can also be used. The unique configuration of power output 402 provides the benefit of preventing a user from operating the parts washer assembly without GFCI unit 122.

As shown in FIG. 4, GFCI unit 122 further includes power input 404. Power input 404 is the element of GFCI unit 122 that allows connection to a power source such as electrical energy. In one example, power input 404 is a traditional 3-prong electrical plug that can be inserted into a standard 220 or 110 V AC wall outlet. In another example, power input 404 is a connection point such as wire leads or electrical terminals such that GFCI unit 122 is hard wired into the electrical system of a garage or other workshop where parts washer assembly 100 may be used.

GFCI unit 122 may further include rear cover 412, back plate 408, and housing 406. These components form the structure of GFCI unit 122 and can, in one example, be constructed of a plastic material of suitable characteristics as known to one or ordinary skill in the art. The rear cover 412, back plate 408, and housing 406 enclose the internal circuitry and electric components of GFCI unit 122. In one embodiment, GFCI unit 122 includes reset mechanism 410. Reset mechanism 410 is the element of GFCI unit 122 that allows a user to restore electric connection to power output 402 if GFCI unit 122 disconnects electrical current in response to the detection of leaking current. In one example, reset mechanism 410 is a push button located on the top surface of housing 406. Any suitable reset mechanism can also be used.

As shown in the embodiments in FIG. 1 and FIG. 4, GFCI unit 122 includes a configuration in which power cord 316 plugs into GFCI unit 122. GFCI unit 122 may also be configured, in an alternate embodiment, such that power cord 316 is hard wired into GFCI unit 122. In this configuration, the user is prevented from bypassing the protection and safety supplied by use of GFCI unit 122.

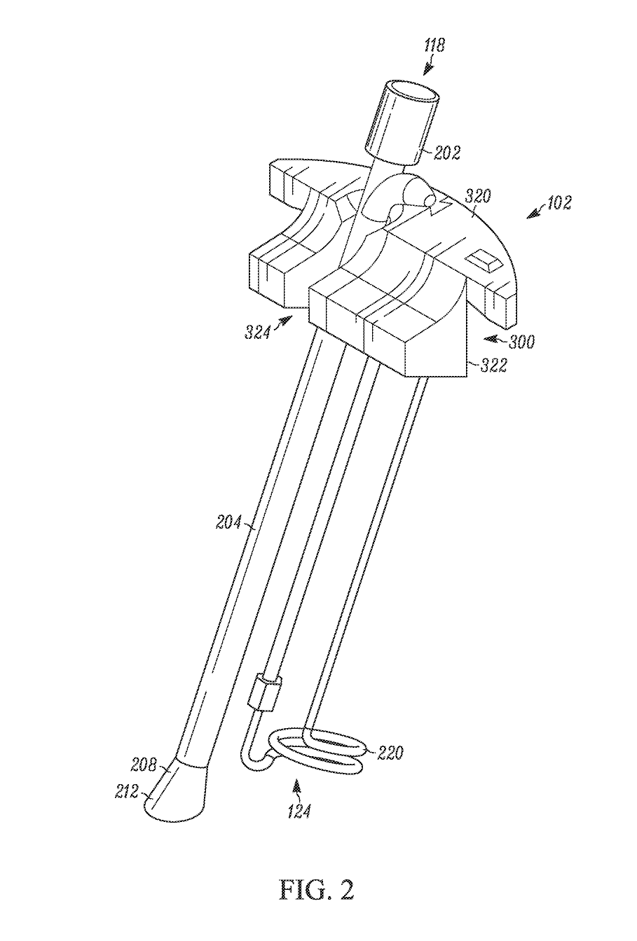

Referring back to FIG. 1, parts washer assembly 100 also includes parts washer module 102. Parts washer module 102, in one embodiment, includes pump assembly 118, heating assembly 124, and control unit 120. Pump assembly 118, in this embodiment, and as further shown in FIG. 2, includes motor 202, return conduit, extension 204, an impeller, impeller housing 208, pump connector 210, and plenum 212. Pump assembly 118 may be any suitable pump configuration but, in one example, a pedestal pump may be used. In the embodiment shown in FIG. 2, motor 202 is a suitable electric motor and is located outside of tank 104. In this configuration, motor 202 is not subjected to the moisture, contaminants and other detrimental properties associated with cleaning solutions that are typically used in connection with the parts washer assemblies. As also shown in FIG. 2, motor 202 is positioned behind receptacle 106, below the upper edge of the upward facing walls of receptacle 106 and behind lid 108 (when in the opened position) such that the motor 202 is protected from being bumped or otherwise damaged. As can be appreciated, the position of the motor 202 in this or a similar location has the benefit of extending the life of the motor 202 and reducing the expense of operation of parts washer assembly 100 through reduced down-time and reduced maintenance and repair.

Motor 202, in one embodiment, is connected to extension 204. Extension 204 is the element of pump assembly 118 that transfers the motion produced by motor 202 to an impeller. In one example, extension 204 includes a steel drive shaft that spins in response to the motion of motor 202. Support bearings may also be included in extension 204. Any suitable type of support bearings can be used such that the drive shaft is sufficiently supported such that the axis of rotation of the drive shaft does not vary and the drive shaft does not wobble. Extension 204 may also include a sheath that surrounds the drive shaft in this example. At the end of extension 204, opposite motor 202, is plenum 212 and impeller housing 208. Plenum 212, in one embodiment is a cone-shaped component that can include an outer surface and an open bottom that allows cleaning solution to be guided into the intake of pump assembly 118 for delivery to dispenser assembly 138. Plenum 212 may also include, as shown in FIG. 1, a series of holes in the outer surface to allow for cleaning solution to flow through the holes and into plenum 212. The series of holes may be sized such that larger particles and debris that reach the volume of cleaning solution in tank 104 are filtered out or prevented from being pumped through pump assembly 118.

Pump assembly 118, in one embodiment, may also include an impeller inside impeller housing 208 at the end of extension 204 opposite motor 202. The impeller may be configured as known to one of ordinary skill the art such that its motion induces movement of cleaning solution for delivery to the dispenser assembly. The impeller is surrounded by impeller housing 208. Impeller housing 208 protects the impeller and its configuration also assists in creating the negative pressure that induces movement of the cleaning solution. The impeller impeller housing 208, and plenum 212 can be made of any suitable material as known to one of ordinary skill in the art. In one example, impeller housing 208, impeller and plenum 212 are constructed of stainless steel, however, other suitable metals, plastics, composite materials, etc. may also be used.

As discussed earlier, motor 202 of pump assembly 118, in one embodiment, is positioned above tank 104 and behind receptacle 106. Also shown in FIG. 1, extension 204 and the other components of pump assembly 118 previously described can be positioned in an angled alignment extending from motor 202 in a manner that results in the distal end of pump assembly 118 terminating at a position forward of the proximal end of pump assembly 118. In this example configuration, the proximal end of pump assembly 118, including motor 202 that is located outside or above tank 104 leans away from tank 104 and provides clearance above tank 104 for the positioning of receptacle 106 and allows for access to motor 202 and the proximal end of pump assembly 118 should maintenance be required. In another embodiment, pump assembly 118 is aligned in a vertical position. In this configuration, motor 202 can be positioned above tank 104 and behind receptacle 106 and extension 204 can be positioned in a substantially vertical position such that it extends down into the cleaning solution. Other configurations can also be used such that a distal end of pump assembly 118 extends into tank 104 and proximal end and motor 202 of pump assembly 118 is positioned outside of tank 104.

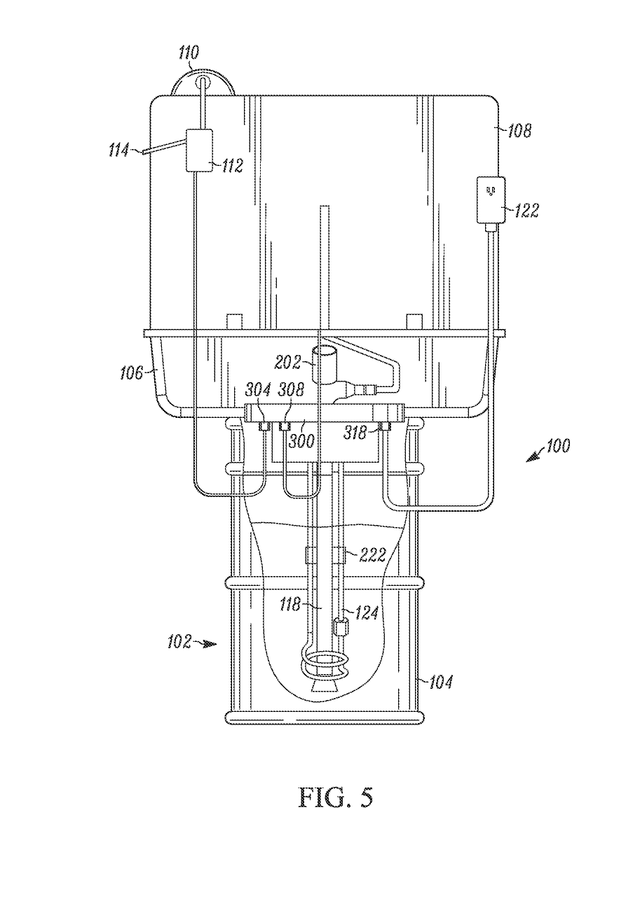

As shown in FIG. 1 and FIG. 2, in one embodiment, parts washer assembly can also include heating assembly 124. Heating assembly 124 introduces heat into the volume of cleaning solution to aid in the cleaning of parts. Heating assembly 124 can include any suitable heating element as known to one of ordinary skill in the art. In one example, heating element may include a portion with a helical shape and is positioned towards the bottom of tank 104 near the distal end of pump assembly 118. In addition, heating assembly 124 can be configured such that it generally follows the angled alignment of pump assembly 118 in tank 104. In one embodiment, heating element is connected to pump assembly 118 by one or more support connectors 222. In other embodiments, however and as shown in FIG. 5, heating element is supported independently of pump assembly 118 such that it can be removed, serviced or replaced without disturbing pump assembly 118.

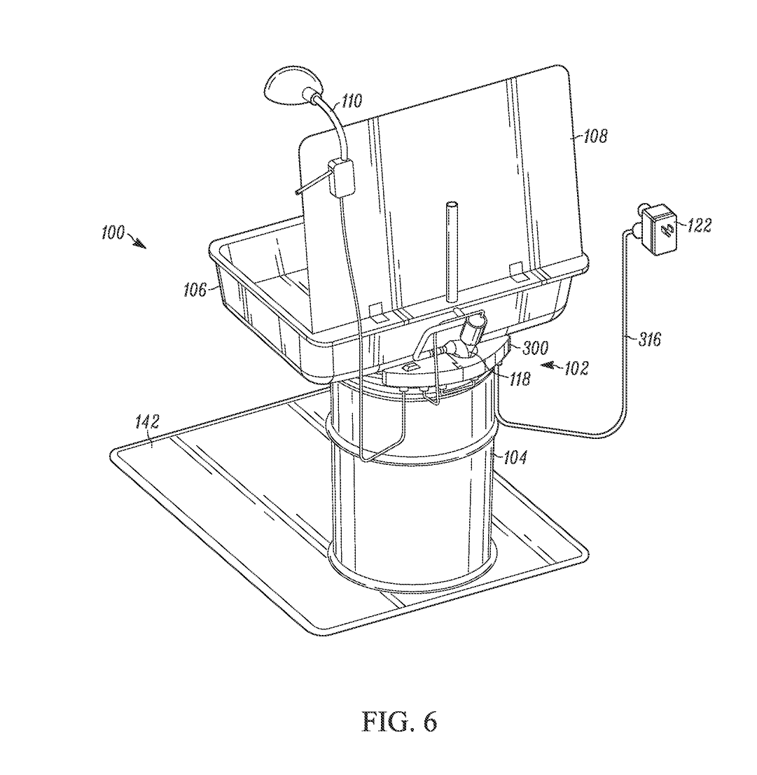

As shown in the embodiment of FIG. 6, parts washer assembly 100, can be positioned on insulating mat 142. As discussed above, parts washer assembly 100 may include heating assembly 124. In such embodiments, the efficiency of the parts washer assembly can be increased if heat loss from heat transfer from tank 104 to the floor or other surface on which the parts washer assembly sits is minimized. In this embodiment, tank 104 is place on insulating mat 142. Insulating mat 142 can be made of any suitable insulating material such as rubber, plastic, synthetic or natural fiber, or the like. Insulating mat 142 can also be foam-filled or have a honeycomb or other structure such that the insulating properties of insulating mat 142 are increased. Other materials, structures and configurations of insulating mat 142 can also be used as are known to one of ordinary skill in the art.

Further included in parts washer module 102, in one embodiment, is control unit 300. Control unit 300 is configured to provide power to the other components of parts washer module 102. Control unit 300 may also provide other functionality such as controlling the operation, cycling, or activation of pump assembly 118, lamp 110, heating assembly 124 or other elements that may be connected to control unit 300. Control unit 300 may provide this functionality automatically in accordance with predetermined operating parameters or in response to input from a user. Control unit 300, in one embodiment, may include lamp module 302, pump module 306, heater module 310, and power module 314. In other embodiments, the aforementioned modules may be combined physically or functionally within control unit 300 or may also be separated, physically or functionally, to provide additional levels of control and operation of parts washer assembly 100.

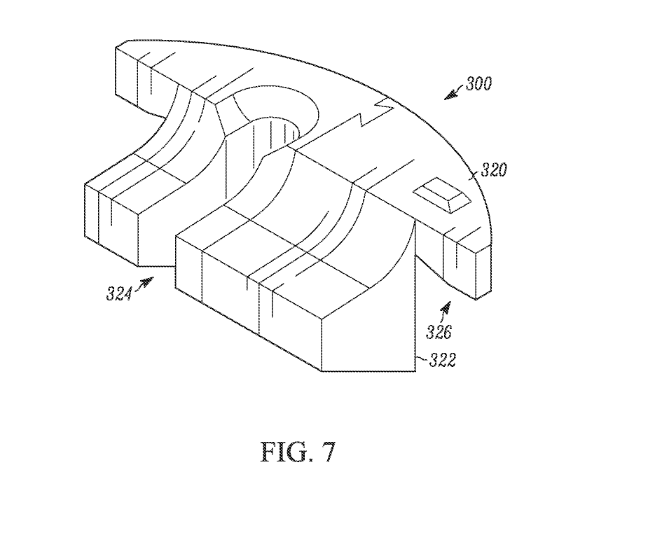

In one embodiment, shown in FIG. 2 and FIG. 7, control unit 300 includes shell 320 that surrounds and protects the inner components of control unit 300 while providing the shape through which control unit 300 interfaces with the other elements of parts washer assembly 100. In the embodiment shown in FIG. 2 and FIG. 7, control unit 300 is moon-shaped or, as seen from above, is the shape of a circular segment. The general size of the circular segment is configured so as to substantially cover the top opening of tank 104 that is left uncovered after receptacle 106 is installed onto the top of tank 104. Control unit 300 may also include flange 322 that extends downward from the upper portion of control unit 300 and is configured to be positioned inside tank 104 and/or below the upper edge of tank 104 to retain control unit 300 relative to tank 104 and receptacle 106. In the configuration of this embodiment, the lower surface of control unit 300 sits on top of the upper edge of tank 104 and flange 322 extends downward into tank 104 generally following the profile of the inner surface contiguous to flange 322.

As described earlier, the top view of control unit 300, in one embodiment, generally follows a circular segment shape. Within this shape, control unit 300 may include one or more openings or slots 324. Slots 324 are defined by vertical walls in control unit 300 such that other elements of parts washer assembly 100 extend through control unit 300 if desired. Control unit 300 may also include retention elements by which other elements of parts washer module 102 can be removably connected to control unit 300 such as, but not limited to, pump assembly 118 and heating assembly 124 and tank 104.

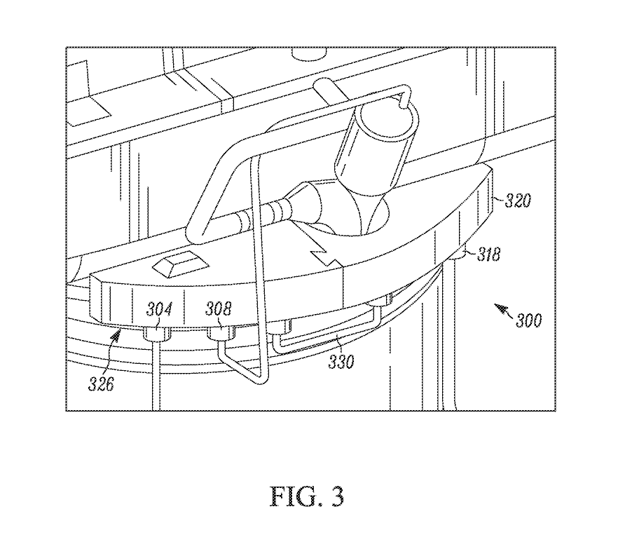

Control unit 300 may additionally include, within shell 320, the electronic circuitry and other elements necessary to provide power to the elements of parts washer assembly and the desired functionality. Further to this end, control unit 300 may include lamp connection point 304, pump connection point 308, and power connection point 318. In one embodiment the connection points of control unit 300 are female plug adapters that allow the connection cords with mating male plug adapters attached thereto to be electrically connected to control unit 300. This type of configuration allows for the disconnection and re-connection of the various elements of parts washer assembly 100 from control unit 300 such that individual elements can be serviced or replaced individually. Also shown in this embodiment, lamp connection point 304, pump connection point 308, and power connection point 318 are disposed on a downward facing connection surface 326. As can be appreciated by one of ordinary skill the art and seen in FIG. 3, in this embodiment, the connection points are accessible when control unit 300 is installed onto tank 104 but their location on connection surface 326 assists in the prevention or reduction of splashes or other debris from falling onto the connection points and causing potential failures or malfunction of parts washer assembly 100. Other locations or configurations of the connections points of control unit 300 may also be used as are known to one ordinary skill in the art.

As shown in FIG. 2, control unit 300 may be a single unit. In other embodiments, as shown in FIG. 3, for example, control unit 300 may consist of separable control modules. In this embodiment, lamp module 302 and lamp connection point 304 and pump module and pump connection point are included on a first piece of control unit 300 while power module and power connection point are included on a second piece of control unit 300. In this configuration, the first piece and the second piece of control unit 300 are joined using a dove tail type joint. In addition, electrical connection between the first piece and the second piece is accomplished via jumper cord 330 and the associated connection points. In embodiments where control unit 300 is divided into separable modules or pieces, other types of connections can be used such as clips, fasteners, integrated joints or others known to one of ordinary skill in the art. In addition, the complimentary surfaces of the separable modules or pieces of control unit 300 may include mating or other integrated electrical connection elements that permit electrical communication between the modules when joined together. Any suitable mating electrical connection can be used as known to one of ordinary skill in the art.

The embodiments of control unit 300 that include separable modules or pieces provide the ability to service, replace, or update individual components of parts washer assembly 100 without the need to replace other elements. In addition, additional functionality can be added in a modular fashion depending on the needs of a user.

In addition to providing the modularity, ease of repair and increased service life of the components of parts washer assembly 100, control unit 300 additionally provides the added benefit of covering tank 104. By limiting the exposure of the volume of cleaning solution to the ambient conditions in which a parts washer assembly resides, evaporation of cleaning solution is reduced and an improvement in the air quality of a work environment is realized.

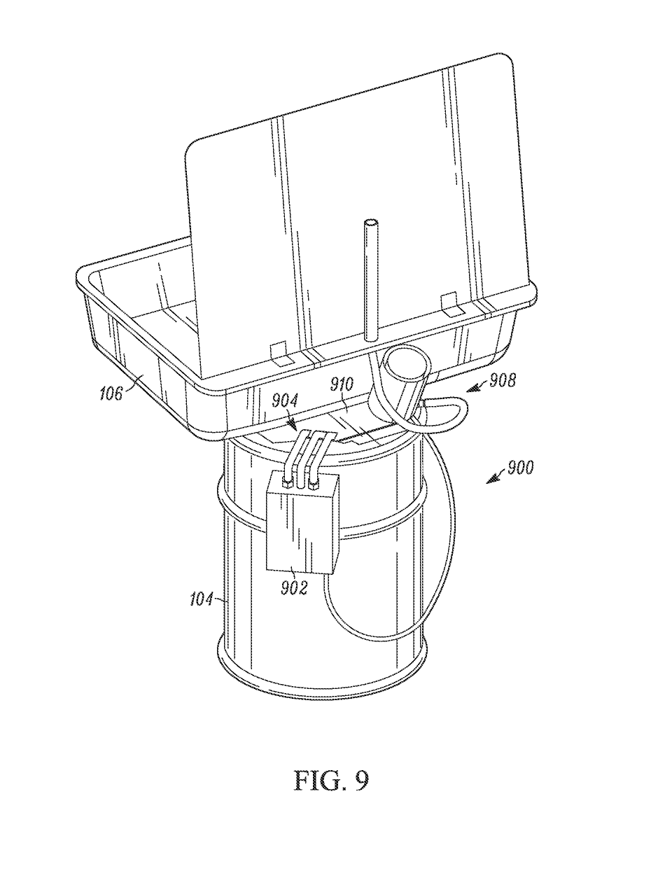

In still another embodiment as shown in FIG. 9, parts washer assembly 900 may include control box 902. In this embodiment, control box 902 is connected to various other elements of parts washer assembly, either physically and/or electrically, including heating unit 904, sensor module 906, and pump assembly 908. As also shown in FIG. 9, this embodiment of parts washer assembly 900 also may include tank 104, receptacle 106, and cover plate 910.

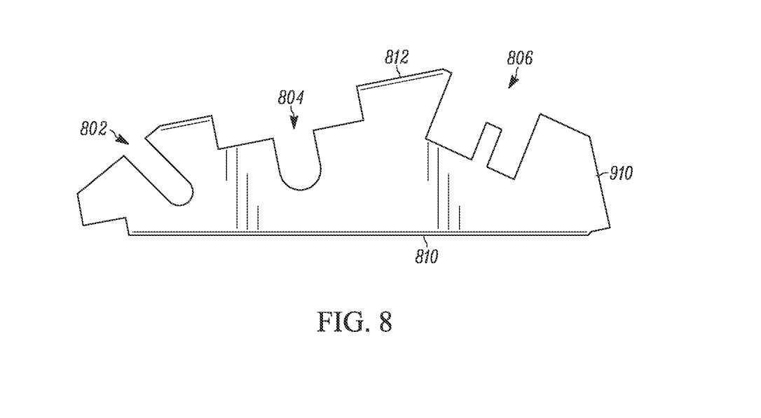

As shown in FIGS. 8 and 9, cover plate 910 can be a substantially flat piece of material that covers a portion of the opening of tank 104 located behind receptacle 106. Any suitable material can be used such as, but not limited to, metals, alloys, plastics, composites, and the like. In one example, stainless steel is used. As further shown in FIGS. 8 and 9, cover plate 910 includes a one or more cut-outs that define openings through which the various elements of parts washer assembly 900 that require access to the inside of tank 104 can be located. As shown, in this embodiment, cover plate 910 may include return slot 802, pump slot 804, and heater slot 806. As can be appreciated, return slot 802 is configured to allow return conduit of pump assembly 908 to extend from a distal end of pump assembly 908 inside of tank 104 to the outside of tank 104 for connection to a dispenser assembly of parts washer assembly 100. Pump slot 804 may be configured to allow installation of pump assembly 908 and heater slot 806 may be included and configured to allow installation of heating unit 904 in parts washer assembly 100.

Further included on cover plate 910, in this embodiment, is cord flange 810 and one or more rim flanges 812. Cord flange 810 can be a down-standing flange configured to substantially follow a cord of the circular top opening of tank 104. Cord flange 810 extends downward from a top surface of cover plate 910 down into tank 104 when cover plate 910 is in an installed position. Cord flange 810 provides added rigidity to cover plate 910 as well as preventing lateral movement of cover plate 910 relative to tank 104. Cover plate 910, in this embodiment, can also include one or more rim flanges 812. Rim flanges 812 can also be down-standing flanges extending downward from top surface of cover plate 910. In the embodiment shown in FIG. 8, cover plate 910 includes two rim flanges positioned on either side of pump slot 804. Rim flanges 812 can be configured such that when cover plate 910 is in the installed position on tank 104, the one or more rim flanges 812 extend downward over a top edge of tank 104 and provide additional stability, rigidity, and hinder movement of cover plate 910 relative to the other elements of parts washer assembly 900. The configuration of cover plate 910 is described relative to the embodiment shown in FIG. 9.

Cover plate 910 may take other configurations and shapes that interface with the other components of parts washer assembly or with the other types of parts washer assemblies previously described as well as others. For example, cover plate 910 may include flanges or other surfaces that can interface with pump assembly 908 such that cover plate is connected to pump assembly 908. Cover plate 910 can be connected to pump assembly 908 via any suitable connection such as, but not limited to screws, bolts, rivets, welds, adhesive or the like. In other examples, cover plate 910 can be connected to control box 902, or heating unit 904. Connection of cover plate 910 to other components provides the benefit of preventing cover plate 910 from being dropped or from falling into tank 104. In other example alternate configurations of cover plate 910, tank 104 may be rectangular shaped and cover plate 910 can be configured to interface with this type of tank as known to one of ordinary skill in the art.

Cover plate 910 provides, among other, the advantages and benefits previously described relative to the other embodiments of control unit 300. These advantages include, but are not limited to, providing for modularity to assist in the repair and maintenance of parts washer assembly 900 as well as reducing evaporation of cleaning solution and improving the air quality of a work environment in which parts washer assembly 900 may be located.

As discussed, in one embodiment, parts washer assembly 900 may include control box 902. Control box 902 may include lamp connection point 926, pump connection point 928, power cord 930, and heating assembly output 912. As shown in this embodiment, lamp connection point 304 can be located on a bottom surface of control box 902. Pump connection point 308 can be located on a side surface of control box 902 and contiguous to pump assembly 908. Heating assembly output 912 can be a connection point but may also be, as shown in FIGS. 8 and 9, a direct connection of heating unit 904 and sensor module 906 to control box 902. In this example, heating unit 904 is an L-shaped resistive heating element with a loop situated substantially parallel to the bottom of tank 104 when installed. The top portion of heating unit 904 extends outward from the longitudinal portions of heating unit 904 such that the top portion hooks over an upper edge of tank 104 and can retain heating unit 904 and control box 902 in position. Heating unit 904 may have other configurations as known to one of ordinary skill in art and may include additional brackets or retention mechanisms in addition to or in place of the configuration of the embodiment previously described.

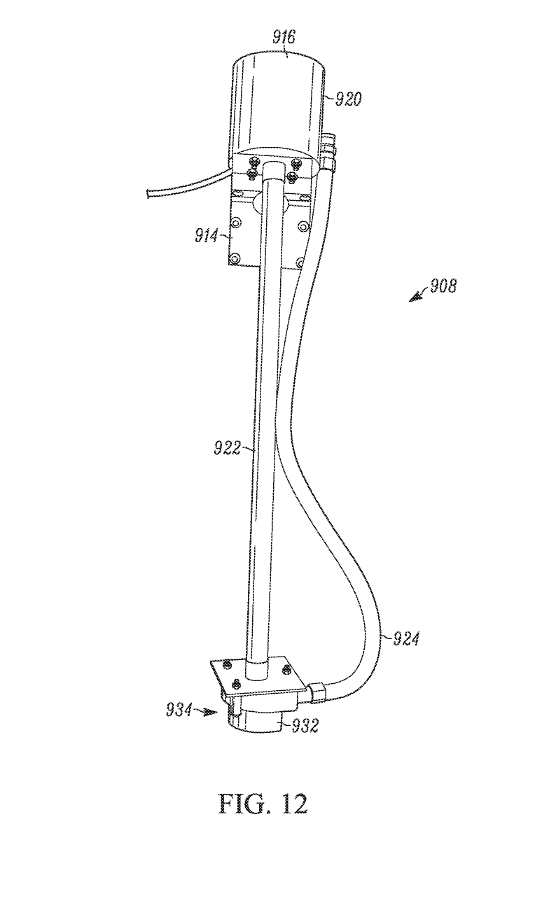

Parts washer assembly 900, in one embodiment, may include pump assembly 908 as shown in FIG. 9 and FIG. 12. In this embodiment, pump assembly 908 includes motor 920, extension 922, impeller 932, impeller housing 934, return conduit 924, support bracket 914, and cage 916. Many of these elements of pump assembly 908 can be substantially the same as or similar to the embodiments and elements previously described. In this example, however, return conduit is configured to be externally located from extension 922. In this embodiment, pump assembly 208 also includes support bracket 914 and cage 916. Support bracket 914, as shown in FIG. 12, can be configured to connect to motor 920 and include surfaces, flanges, or the like that interface with tank 104 and/or cover plate 910 to retain and support pump assembly 908 in a desired position. Support bracket 914 may be constructed of any suitable material such as, but not limited to, metals, alloys, plastics, composites and the like.

Further included on pump assembly 908, in this embodiment, is cage 916. Cage 916 can be configured to substantially surround motor 920 so as to protect motor 920 from damage. Also, since motor 920 can heat up during extended periods of operation, cage 916 prevents a user from touching motor 920 when it has become hot and assists in cooling the motor due to the increased surface area of cage 916. In one example, cage 916 is a cylindrically shaped element fixed in place around motor 920. Other types and shapes of cage 916, as known to one of ordinary skill in the art may also be used.

The embodiment of parts washer assembly 900, as shown in FIG. 9, can provide the advantages and benefits as described above including a reduction in maintenance and down-time due to the location of motor 202 external to tank 104 and behind receptacle 106. The modular construction of parts washer assembly 100, in this embodiment, also can provide reduced maintenance and repair costs by allowing service technicians to replace or repair individual elements without the need to disassemble the entire, or significant portions of parts washer assembly 100.

The preceding detailed description is merely some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the invention without undue burden.

1. A parts washer assembly including a tank containing a volume of cleaning solution and a receptacle disposed on top of the tank for cleaning parts, the parts washer assembly comprising:
a control unit disposed on top of the tank and covering at least a portion of an opening of the tank; and
a pump assembly operably connected to the control unit comprising a motor and extension, the motor disposed above the control unit and the extension operably connected to the motor and extending into the tank.

2. The parts washer assembly of claim 1 wherein the control unit further includes at least one connection point located outside of the tank.

3. The parts washer assembly of claim 2 wherein the motor is connected to the at least one connection point.

4. The parts washer assembly of claim 1 further comprising a GFCI unit wherein a power output of the GFCI unit includes a unique electric connector configuration complimentary to a power cord of the parts washer assembly.

5. The parts washer assembly of claim 1 further comprising a heating assembly connected to the pump assembly.

6. The parts washer assembly of claim 1 wherein the motor is disposed behind the receptacle.

7. The parts washer assembly of claim 1 wherein the control unit comprises:
a shell including a connection surface;
a flange extending downward from the shell; and
at least one connection point located on the connection surface; and
wherein the connection point is located outside of the tank, and the flange extends into the tank.

8. A pump assembly for use with a parts washer assembly, the pump assembly comprising:
a motor disposed above a tank of the parts washer assembly; and
an extension connected to the motor and extending into the tank at an angle such that a distal end of the extension is forward of the motor, wherein the motor and extension is configured to transfer cleaning solution from the tank to a receptacle of the parts washer assembly.

9. The pump assembly of claim 8 further comprising an impeller and plenum, the impeller and plenum disposed at the distal end of the extension.

10. The pump assembly of claim 9, wherein the plenum is substantially cone-shaped and includes a plurality of openings configured to allow cleaning solution to flow therethrough.

11. A control unit for use with a parts washer assembly, the control unit comprising:
a shell including a connection surface;
a flange extending downward from the shell; and
at least one connection point located on the connection surface; and
wherein the shell of the control unit is configured to cover at least a portion of an opening of a tank of the parts washer assembly while the connection point is located outside of the tank, and the flange extends into the tank.

12. The control unit of claim 11 wherein the connection surface is downward facing and interacts with an upper edge of the tank.

13. The control unit of claim 11 further comprising:
a first piece;
a second piece configured to disconnect and re-connect to the first piece, and
wherein the at least one connection point comprises a pump connection point and a power connection point, the pump connection point located on the first piece and the power connection point located on the second piece.

14. The control unit of claim 11 wherein the connection surface is downward facing.

15. The control unit of claim 11 configured to removably connect to an upper edge of a tank of the parts washer assembly behind a receptacle that is installed onto the tank.

16. The control unit of claim 11 wherein the at least one connection point comprises a pump connection point, a power connection point, a lamp connection point and a heater connection point.

17. A parts washer assembly including a tank containing a volume of cleaning solution and a receptacle disposed on top of the tank for cleaning parts, the parts washer assembly comprising:
a control box including a lamp connection point and a pump connection point;
a heating unit connected to the control box;
a pump assembly coupled to the control box via the pump connection point, the pump assembly including a motor positioned above the tank and an extension extending downward from the motor into the volume of cleaning solution in the tank; and
a cover plate configured to cover a portion of an opening of the tank.

18. The parts washer assembly of claim 17 wherein the cover plate comprises a plurality of slots configured to receive the heating unit and the pump assembly.

19. The parts washer assembly of claim 17 wherein the cover plate comprises a cord flange and at least one rim flange, the cord flange and the at least one rim flange configured to prevent movement of the cover plate relative to the tank.

20. The parts washer assembly of claim 17 wherein the pump assembly further comprises a support bracket configured to position the pump assembly in a location behind the receptacle and a cage configured to substantially surround the motor.

21. A method for repairing a parts washer assembly, the parts washer assembly including a pump assembly comprising a motor and an extension, the extension extending into a volume of cleaning solution contained in a tank, the method comprising the steps of:
removing a motor from the pump assembly without removing any portion of the pump assembly from the volume of cleaning solution; and
replacing the motor with a new motor.

22. A method for servicing a parts washer assembly, the parts washer assembly including a sink positioned over a first portion of an opening of a tank of cleaning solution and a cover plate positioned over a second portion of the opening of the tank of cleaning solution, the method comprising the steps of:
removing a cover plate to expose the second portion of the opening of the tank,
removing one of a malfunctioning heater assembly and a malfunctioning pump assembly; and
installing one of a repaired heater assembly and a repaired pump assembly;
wherein during the steps recited above, the first portion is not exposed.
